(19) United States
(12) Patent Application Publication
(10) Pub. No.: US 2007/0028453 A1
(43) Pub. Date: Feb. 8, 2007

(54) PORTION CONTROL SERVING UTENSILS

(76) Inventor: Frederick W. Crow, Lebanon, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/535,635

(22) Filed: Sep. 27, 2006

Related U.S. Application Data
(63) Continuation-in-part of application No. 10/891,781, filed on Jul. 15, 2004.
(60) Provisional application No. 60/488,162, filed on Jul. 18, 2003.

(51) Int. Cl. A47J 43/28

(52) U.S. Cl. 30/147

(57) ABSTRACT

A portion control, food serving system comprises a series of two or more interchangeable utensil portions configured to receive an amount of food, a handle portion, removably and operably attachable to one of the utensil portions incorporating a display device and a data input system, and electronics to operate the data input system and the display device. The data input system is operable to receive nutritional data associated with the food, including a standard serving size of the food. The electronics are operable to weigh the amount of food received on one of the utensil portions and produce a visual representation on the display device of the amount of food relative to the standard serving size of the food.

### CROSS-REFERENCE TO RELATED APPLICATIONS

This application is a continuation-in-part of U.S. Ser. No. 10/891,781, filed Jul. 15, 2004, which is based on provisional patent application Ser. No. 60/488,162, filed Jul. 18, 2003, and priority and the benefit of Ser. Nos. 10/891,781 and 60/488,162 is claimed in the present application to the extent the subject matter of this application is found in these previously filed applications. The content of these applications is incorporated herein by reference.

### FIELD OF THE INVENTION

The present disclosure generally relates to serving utensils and more specifically to a serving utensil device that provides an indication of the weight of the food received on the serving utensil relative to the standard serving size of the food.

### BACKGROUND

Obesity and being overweight are currently recognized to be at almost epidemic proportions in the United States. This is a problem that is currently emerging and is the topic of much interest and discussion. People constantly underestimate their weight and underestimate the amount of food they eat.

Excess weight can increase the risk of or cause diabetes, cardiovascular diseases, high blood pressure, stroke, joint pain, arthritis, sleep apnea, and several types of cancers including, but not limited to, breast, colon, prostate and kidney. Excess weight and inactivity is estimated to account for over tens of thousands of premature deaths each year.

Experts estimate that the percentage of overweight adults is as high as 60 to 65% in the United States alone. The problem doesn't rest only with adults. Reports indicate that since 1980, the number of overweight children has tripled, and that up to 25% of U.S. children are obese. It has been reported that unless people start eating less and exercising more, one in three children in the U.S. born in the year 2000 will become diabetic.

A common problem relating to the overweight and obesity dilemma is that one's eyes measure what is put on a plate, and that measurement of food is seldom, if ever, a “standard serving size”. A portion is the amount a user puts on his plate to eat. Oversize portions are a factor in the overweight and obesity dilemma. A “serving size” of a particular food is a standard amount set by the United States government, either by the U.S. Department of Agriculture with its Food Guide Pyramid or by The Food and Drug Administration's Nutritional Facts Label. In 1990, the Nutrition Labeling and Education Act of 1990 (NLEA Public Law 101-535) established the Nutrition Facts Panel that references standard serving sizes. These standard serving sizes represent the amounts customarily consumed and provide a standard measurement for nutritional values. Serving sizes for particular foods can be found on the Nutrition Facts Panel (label), on websites, recipes and food packages. Nutritional content, including the number of calories and the amount of fat, is given in terms of serving size. Proper and accurate serving size measurement is necessary to permit the consumer to monitor his or her food intake, and consequently, the intake of sugar, fat, sodium, and cholesterol, for example. Accurate serving size measurement encourages portion control and thus, weight management.

### BRIEF DESCRIPTION OF THE DRAWINGS

FIG. 1 is a top plan view of a serving utensil device according to one embodiment of the present disclosure.

FIG. 2 illustrates various serving utensils that may be used with the serving utensil device of FIG. 1.

FIG. 3 illustrates various handle covers that may be used with the serving utensil device of FIG. 1.

FIG. 4 is a top plan view of the handle mechanism of the serving utensil device of FIG. 1.

FIG. 5 is a schematic view illustrating the system utilized with the serving utensil device of FIG. 1.

FIG. 6 illustrates the control buttons of the serving utensil device of FIG. 1.

FIGS. 7-17 illustrate various possible visual indications to be shown in a display device component of the serving utensil device of FIG. 1.

### DESCRIPTION OF PREFERRED EMBODIMENTS

While the present disclosure may be embodied in many different forms, for the purpose of promoting an understanding of the principles of the disclosure, reference will now be made to the embodiments illustrated in the drawings and specific language will be used to describe the same. It will nevertheless be understood that no limitation of the scope of the disclosure is thereby intended. Any alterations and further modifications in the described embodiments, and any further applications of the principles of the disclosure as described herein are contemplated as would normally occur to one skilled in the art to which the disclosure relates.

The present disclosure generally concerns a food serving device. The device generally includes a utensil portion and a removable handle portion with a display screen and a data input system. In certain embodiments, the data input system is operable to receive nutritional data associated with the food, the nutritional data including a standard serving size of the food. Further, the device includes electronics operable to weigh the quantity of food received on the utensil portion and provide a visual indication on the display screen representing the weight of the quantity of food relative to the standard serving size of the food.

In certain embodiments, the user of the device selects the food to be served and determines the standard serving size of the food (by weight). The user inputs the standard serving size of the food into the device via the data input system. In certain other embodiments, the user can input a personalized daily calorie goal (other than the standard 2000 calories per day goal) and the standard serving size of the food into the device via the data input system and ascertain a personalized serving size of the food. The serving utensil has weighing capabilities; therefore, as food is added or removed from the serving utensil, the device provides a continuously updated visual indication on the display screen representing the weight of the food relative to the standard serving size. The user can then maintain, add to, or remove from the portion amount as desired, or until 1 standard serving size is reached.

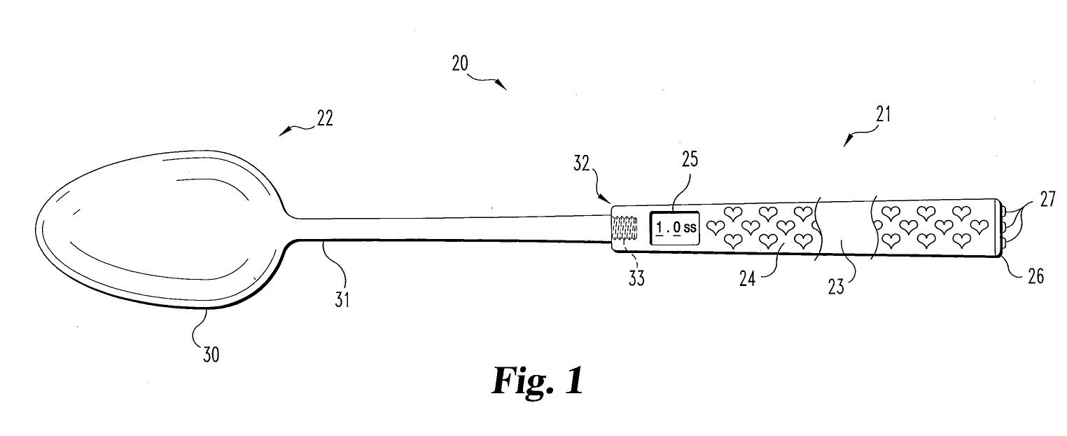

Referring to FIG. 1, a serving utensil device 20 according to certain embodiments is shown. The device 20 generally includes a handle portion 21 for holding the device 20, operably and removably connected to a utensil portion 22 for obtaining, transferring, and serving food. The handle portion 21 generally includes a body 23, a cover 24, an operator display device 25, an end cap 26, and input control buttons 27. In the illustrated embodiment, the display device 25 shows a reading of 1.0 standard serving size (“ss”). The utensil portion 22 generally includes a utensil head 30 and a utensil stem 31. The handle portion 21 further includes a threaded receiving bore 33 within the body 23.

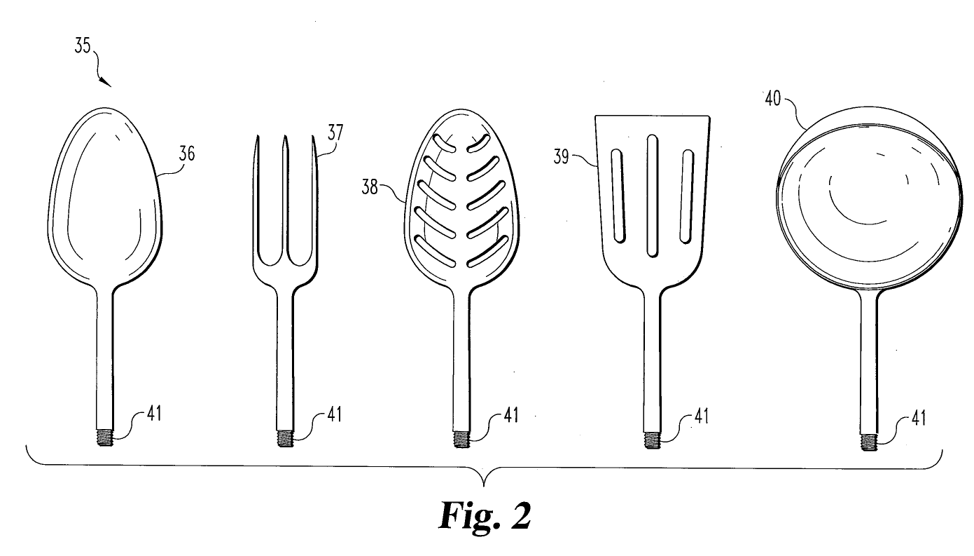

Referring to FIG. 2, there are various possibilities of utensils 35 that could be interchangeably utilized within the device 20. As examples, FIG. 2 illustrates a spoon 36, a fork 37, a slotted spoon 38, a spatula 39, and a ladle 40. However, it is contemplated that the device 20 can be interchangeably utilized with various other utensils as would generally occur to one skilled in the art, such as an ice cream scoop (not shown). In certain embodiments, the utensils 35 (and utensil portion 22) are made from a stainless steel material. In other embodiments, the utensils 35 (and utensil portion 22) are made from a plastic material, often preferred for use with non-stick cookware.

The handle portion 21 and the utensil portion 22 are operably and removably connected together by any appropriate means as would generally occur to one skilled in the art. In the illustrated embodiment, the handle portion 21 and the utensil portion 22 are operably and removably connected through the use of screw connectors, enabling the user of the device 20 to screw the utensil portion 22 into the handle portion 21. In such embodiments, the utensils 35 include utensil screw members 41 for connection with the handle portion 21. The utensil screw member 41 (shown in FIG. 2) can mate with the threaded receiving bore 33 on the inner surface of the body 23 of the handle portion 21 (shown in FIG. 1). The utensil stem 31 of the utensil portion 22 is screwed into the handle portion 21 at a connection point 32. In other embodiments, the handle portion 21 and the utensil portion 22 can be connected through the use of screws, nut and bolt combinations, clamps, guide pins, sliding, tab in slot arrangements, or connectors wherein friction maintains the connection. The handle portion 21 and the utensil portion 22 being operably and removably connected together allows for interchangeable use of various optional serving utensils 35 with the handle portion 21.

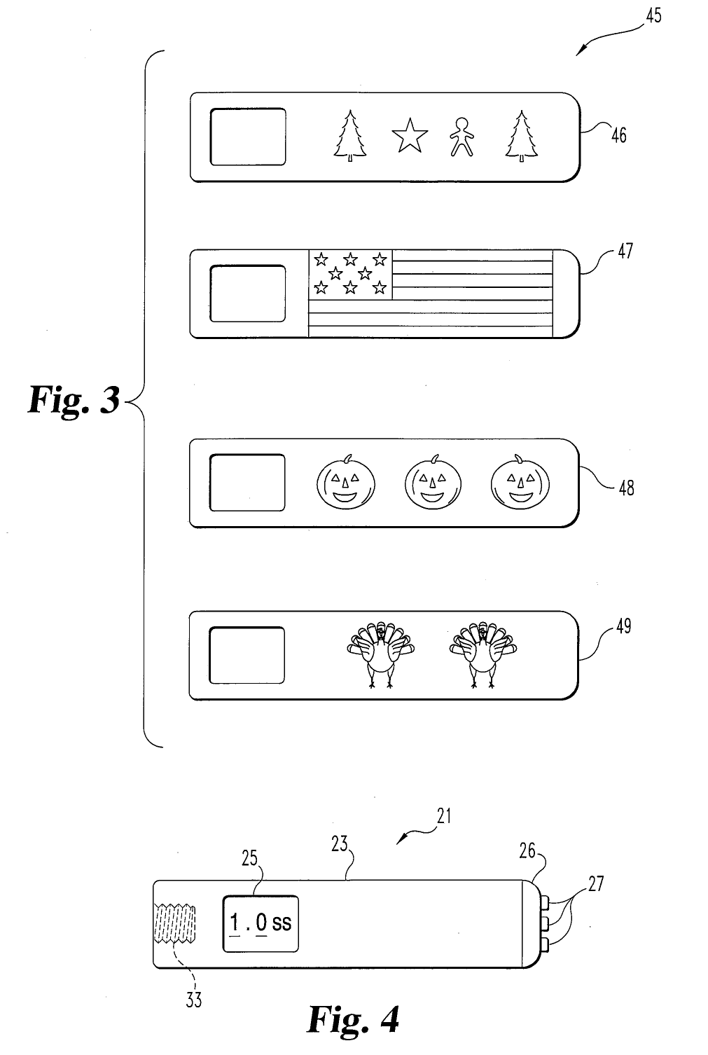

FIG. 3 illustrates examples of various decorative covers 45 that can be utilized with the device 20. The cover 24, shown in FIG. 1, includes a heart design that is typical of Valentine's Day décor and is one specific example of a decorative cover, such as those shown in FIG. 3. Further examples of the possible decorative covers are shown in FIG. 3, including a Christmas design cover 46, a United States flag design cover 47 for celebrating the Fourth of July or other similar holidays. Further, there is shown a Halloween design cover 48 and a Thanksgiving design cover 49. It is contemplated that other decorative design covers (not shown) could be used in conjunction with the device 20.

As illustrated in FIG. 3, the covers 45 (and cover 24) can contain openings 50 through which the operator display device 25 (shown in FIG. 1) can be seen. In certain embodiments, the decorative covers 45 (and cover 24) are removable from the device 20. The decorative covers 45 (and cover 24) can be configured to slide over the handle portion 21, positioning the opening 50 over the operator display device 25. In other embodiments, the decorative covers 45 (and cover 24) include a zipper mechanism to allow for ease of placement on and removability from the handle portion 21. In certain embodiments, the decorative covers 45 (and cover 24) are formed from a heat resistant, non-flammable, and washable material, such as a woven fabric or similar type of material. As examples, the decorative covers 45 (and cover 24) can be formed from cotton, nylon, or polyester materials. In certain embodiments, the covers 45 and 24 are treated before use, such as by ultraviolet light or chemically, to inhibit cross contamination of germs, bacteria, and viruses, from multiple users of the serving utensil device 20. In such embodiments, the covers 45 and 24 can include applications of germicide substances, such as antibacterial or antiviral solutions.

Referring to FIG. 4, there is shown the handle portion 21 without a cover. In the illustrated embodiment, the operator display device 25 is located directly on the body 23. The operator display device 25 may be of a conventional design, such as a liquid crystal display (LCD), plasma, light emitting diode (LED), or such other type as would occur to those skilled in the art. Additionally, the end cap 26 of the handle portion 21 is operably and removably connected to the body 23, with input control buttons 27 operably connected to the end cap 26. In certain embodiments, the device 20 is battery operated. In such embodiments, end cap 26 is removed and batteries are placed in the body 23 for powering the device 20. However, it is contemplated that the device 20 can be operated by any appropriate power means as would occur to one skilled in the art.

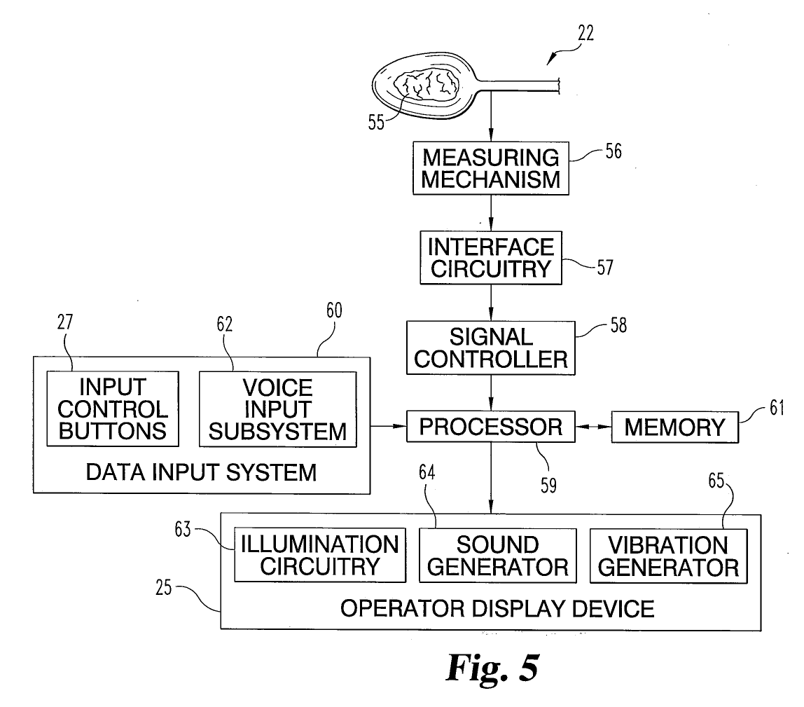

Referring to FIG. 5, as illustrated, the device 20 can incorporate various electronic systems and circuitry elements that perform the functions associated herein, such as, but not limited to, a measuring mechanism 56, interface circuitry 57, a signal controller 58, a processor 59, a data input system 60, a memory system 61, and the operator display device 25. Interface circuitry 57, which can be of an analog type, is responsive to control signals from the measuring mechanism 56 operably connected to the utensil portion 22, containing a quantity of food 55, to provide corresponding analog stimulus signals via the appropriate circuitry.

In certain embodiments, signal controller 58 includes logic systems to alert the user of the device 20 when the standard serving size of the food has been attained or to alert the user of the device 20 of the measurement of the portion size of the food received on the utensil portion 22. The device 20 can further include one or more digital-to-analog converters (DAC) to facilitate operation of the device 20 in the manner to be described in greater detail hereinafter. Processor 59 is coupled to signal controller 58 to communicate therewith, to selectively provide output to the operator display device 25, and to selectively respond to input from the data input system 60.

The operator display device 25 can include additional elements such as illumination circuitry 63 for lighting the operator display device 25 at night or in low-light conditions, a sound generator 64, and/or a vibration generator 65. The sound generator 64 and vibration generator 65 can be utilized as types of alarm circuitry to alert the user when the standard serving size of the food has been attained on the utensil portion 22. In one embodiment as shown in FIG. 1, the data input system 60 involves the use of input control buttons 27. Alternatively or additionally, one or more other input devices can be utilized, such as a voice input subsystem 62, for example. Memory system 61 can be associated with processor 59 or alternatively can be separate from or at least partially included in one or more of signal controller 58 and processor 59. Memory system 61 can be at least partially integrated with circuitry 57, signal controller 58, and/or processor 59.

The device 20 further includes an electronic power supply system. In a simplified embodiment (as described above), the device can be operated by batteries located within the body 23 of the handle portion 21. However, it should be appreciated that the device 20 can be operated by any appropriate power supply as would occur to one skilled in the art. The power supply used to operate the device 20 is operably coupled to the appropriate circuitries involved in the operation of the device 20.

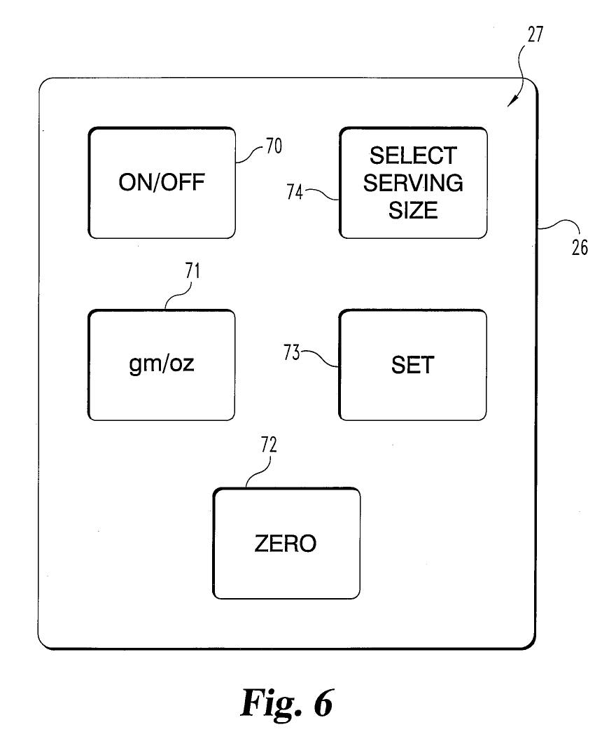

Referring to FIG. 6, the end cap 26 with the input control buttons 27 is shown. The input control buttons 27 are operably connected to various data input systems as would generally occur to those skilled in the art. In the embodiment illustrated in FIG. 6, there are five input control buttons 27, including an “on/off” button 70, a “grams/ounces” button 71, a “zero” button 72, a “set” button 73, and a “select serving size” button 74. However, it should be understood that various other combinations of input control buttons 27 can be incorporated into the device 20 as would generally occur to those skilled in the art. Additionally, it should be appreciated that the input control buttons 27 can be located at different positions on the handle portion 21. The input control buttons 27 can be combined into one or more input control buttons with the inclusion of more complex electronic circuitry.

Generally referring to FIGS. 1-6, to operate the device 20 the user or operator begins by selecting the food to be served, and determining the corresponding standard serving size amount of that food by weight. The standard serving size can be ascertained from the nutritional label or the nutritional facts panel found in or on websites, recipes or packaging associated with the food to be consumed. The operator selects the desired utensil tool to be used, based at least in part on the selected food, and connects the desired utensil portion 22 to the handle portion 21.

The user inputs nutritional data information into the handle portion 21 via the input control buttons 27. In preferred embodiments, the user of the device 20 inputs the standard serving size amount into the device. Often, the standard serving size of a food item is a weight quantity, with units of grams or ounces. In certain embodiments, the user of the device 20 can also input the number of calories associated with the standard serving size amount of the food to be consumed. It is contemplated that the nutritional data information can be entered into the device 20 in a pre-programmed manner or via other transmission methods, and in certain embodiments, the data can be stored in a memory system of the device 20. As examples, such nutritional data information can include carbohydrates, fat, sugar, fiber, dietary points such as weight watcher points, or other nutritional data.

Regarding use of the device 20 with reference to the operator control buttons 27, the user can turn on the device 20 by activating an on/off actuator such as button 55. The user can select the desired measuring units, e.g., grams or ounces, by activating button 56 until the correct unit of measurement is displayed in the operator display device 25. The user can “zero out” or calibrate the device by activating a zero button such as button 57. Activating button 57 or initiating a similar action will set the measurement to 0 grams or 0 ounces after attachment of the selected serving utensil 22. Thus, the weight measurement of the selected serving utensil 22 will not be included and only the food obtained thereon will be weighed or measured. Additionally, the user can input the standard serving size amount by activating the select serving size button 58. The button 58 can be configured so that each press of button 58 increases the measurement by a fixed amount, e.g., by 1 gram or 1 ounce. Once the standard serving size is shown in the operator display device 25, the user can press the set button 59.

The user of the device 20 acquires a food serving with the use of the utensil portion 22. It is contemplated that when using the device 20 to serve the food, the user can ascertain the amount of the food received on the utensil portion 22 relative to the standard serving size of the food via visual, auditory or tactile mechanisms. In certain embodiments, a visual indication is displayed in the operator display device 25 representing the amount of food on the utensil portion 22 relative to the standard serving size. In other words, the operator display device 25 can provide a visual indication to the user of the device 20 in terms of more than, less than or equal to a standard serving size of that particular food.

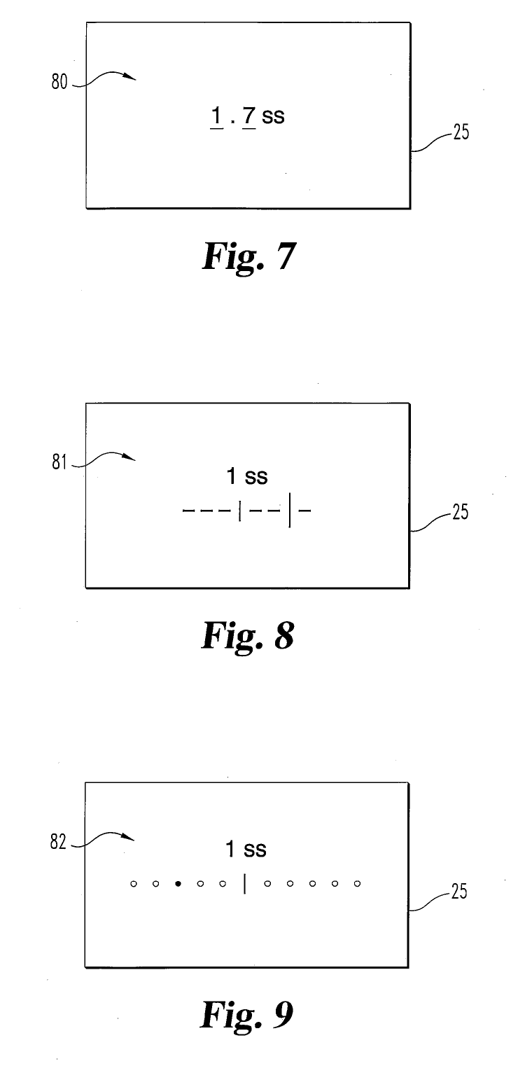

FIGS. 7-17 illustrate example visual indications that can be shown in operator display device 25. FIGS. 7-11 represent example visual indications 80-84, respectively, to represent the weight of the food on the utensil portion 22 relative to the standard serving size of the food. Visual indication 80 includes displaying a factor of the standard serving size, labeled “ss”. In the example shown in FIG. 7, the amount of food is greater than the standard serving size by a factor of 1.7. The amount of food on the utensil portion 22 can be adjusted until the visual indication 80 reads 1.0 ss, indicating that 1 standard serving size has been achieved.

Visual indications 81 and 82 represent continuously updating scales illustrating the weight of the food received on the utensil portion 22 relative to a standard serving size “ss”. In visual indication 81, a shorter vertical line remains directly under the “1 ss” label at a standard serving size, and the larger vertical line represents the amount of food received on the utensil portion 22. The illustration of FIG. 8 indicates to a user of the device 20 the amount of food is greater than a standard serving, in that the larger line is positioned to the right of the “1 ss” label line. Visual indication 82 is another type of scale representation, indicating to a user of the device 20 the amount of food received on the utensil portion 22 is less than a standard serving size, in that a circle to the left of the “1 ss” label line is darkened.

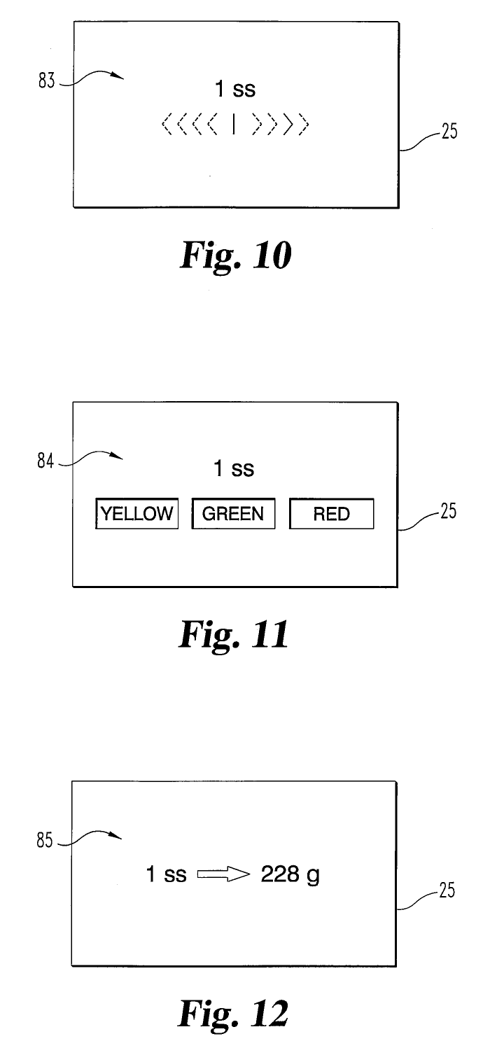

As another example, visual indication 83 of FIG. 10 illustrates a “1 ss” label line with greater than and less than dotted arrows to the right and left, respectively, thereof, and with the amount of food on the utensil portion 22 represented by a solid arrow. Additionally, colors could be used to visually represent the weight of food received on utensil portion 22 relative to the standard serving size. For example, visual indication 84 of FIG. 11 provides green, yellow and red lights, with the green light illuminating when a standard serving size has been reached, the yellow light illuminating when the amount of food is within a first range of the standard serving size and the red light illuminating when the amount of food is within a second range relative to the standard serving size. It should be appreciated that other color indication methods can be used to represent the amount of food received on utensil portion 22 relative to a standard serving size amount. It should also be appreciated that other types of graphs and scales, or other types of visual indications, can be used with the device 20 as would generally occur to one skilled in the art.

In certain other embodiments, the device 20 alerts the user by a sound that the standard serving size has been reached. As an example, the sound can be that of an animated character voice from a children's televisions show, such as Barney or SpongeBob Squarepants, as examples. In other embodiments, the device 20 alerts the user by a light that a standard serving size has been achieved. In even other embodiments, the device 20 alerts the user via tactile mechanisms, such as by a vibration. A vibration or a similar type of indicating mechanism aids in maintaining privacy for the user of the device 20. The device 20 can be configured so that the indicating mechanism is activated for a short time period or continues until the amount of food on the utensil portion 22 reaches a level below the standard serving size. However, it should be appreciated that the device 20 can be configured and designed in other ways and/or include different indicating mechanisms to alert the user that a standard serving size has been attained and/or provide a representation of the weight of the food relative to a standard serving size amount.

Based on the indication, whether it be visual, auditory, tactile, or via other mechanisms, the user of the device 20 can alter the amount of food on the utensil portion 22, by adding or removing food, until the standard serving size amount of that food is achieved. Thereafter, the standard serving size amount of the food received on the utensil portion 22 can be served.

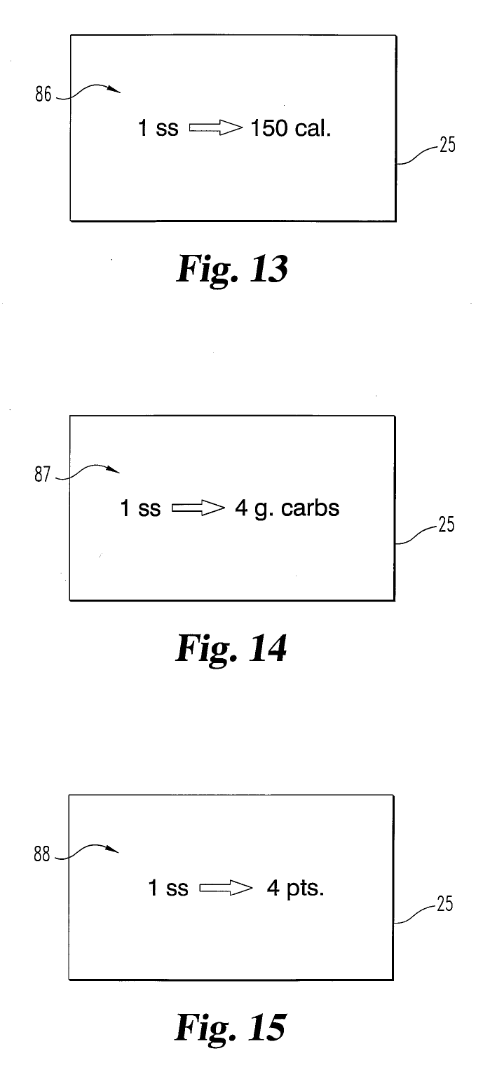

FIGS. 12-15 illustrate visual indications 85-88, respectively, showing example nutritional data information entered, pre-programmed, or otherwise transmitted into the device 20. In such embodiments, after a standard serving size of food is achieved, the user of the device 20 can toggle through the nutritional data information associated with that standard serving size. As examples, the user can view the total weight of the food, in grams, in the standard serving size (FIG. 12), the number of calories in the standard serving size (FIG. 13), the amount of carbohydrates, in grams, in the standard serving size (FIG. 14), or the number of Weight Watchers® points in the standard serving size (FIG. 15). However it should be appreciated that other nutritional data can be accessed through the device 20 as would occur to one skilled in the art. In certain other embodiments, an auditory mechanism in the device 20 can inform the user of the device 20 of the nutritional data associated with the standard serving size.

The standard serving size of a food item is most often determined or associated with a 2000 calories per day diet. However, some users of the device 20 may have a personalized diet of other than 2,000 calories per day, resulting in a personalized serving size (“pss”) different than the standard serving size of the food. In such situations involving a personalized calorie diet, the user can enter into the device 20 the personalized calories per day diet and the standard serving size of the food, and the device 20 is operable to determine the personalized serving size amount of the food. Additionally, in certain embodiments, the device 20 is operable to also provide nutritional information for the food associated with the personalized serving size amount. For example, the device 20 could provide the user with the number of calories of the food in the personalized serving size amount. Similar to achieving a standard serving size amount of the food, the device 20 can provide similar indications representing the amount of food received on the utensil portion 22 relative to the personalized serving size. Accordingly, in such embodiments, the user can adjust the amount of food received on the utensil portion 22 until the personalized serving size is achieved.

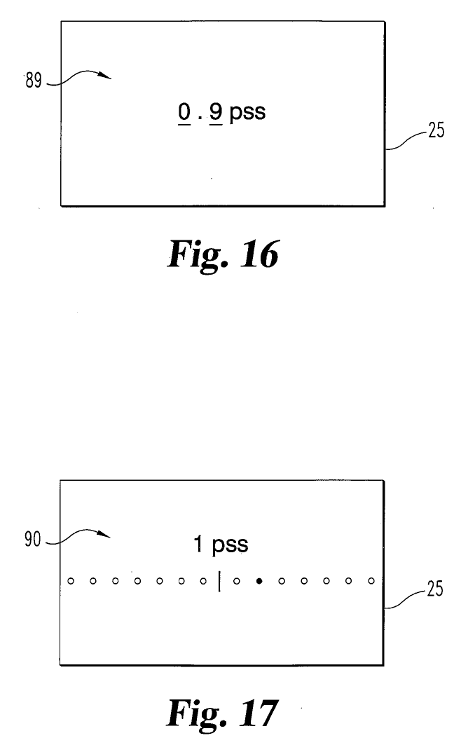

FIGS. 16 and 17 illustrate visual indications 89 and 90, respectively, representing the weight of the food on the utensil portion 22 relative to a personalized serving size (“pss”) amount of food. Visual indication 89, similar to visual indication 80, provides a factor of the personalized serving size “pss”. In the example shown in FIG. 16, the amount of food is less than the personalized serving size amount by a factor of 0.9. The amount of food on the utensil portion 22 can be adjusted until the visual indication 89 reads 1.0 pss, indicating that 1 personalized serving size has been achieved. Visual indication 89, similar to visual indication 82, is a scale representation, indicating to a user of the device 20 that the amount of food received on the utensil portion 22 is greater than a personalized serving size, via a circle to the right of the “1 pss” label line being darkened. It should be appreciated that other types of graphs and scales, or other types of indications, can be used with the device 20 in relationship to a personalized serving size amount as would generally occur to one skilled in the art.

To operate the device 20 further with a different user or a different food item, the user can press the zero button 57 to “zero out” the device 20. Continued and consistent use of the device 20 may assist the user to better visualize the appropriate portion sizes of various food items at times when the device 20 is not available for use. This trains the user to visually learn when a portion equals a standard serving size of a particular food. This also assists the user to consume only one standard serving size, as the hunger urge is less strong after having eaten one serving size and the user is less likely to return for second and third portions.

The device 20 can weigh or measure the amount of food contained on the utensil portion 22 by any appropriate means as would occur to one generally skilled in the art. In one embodiment, the device 20 includes weighing sensors at or near the connection point 32 and disposed within the body 23. The weighing sensors are operably connected to the circuitry of the device 20 and are in communication with the operator display device 25. In another embodiment, a strain gauge or similar mechanism may be located within the body 23 of the handle portion 21 to measure the amount of food received on the utensil portion 22. This embodiment preferably includes an analog-digital converter to convert the strain gauge output to a signal recognizable by the circuitry used by the device 20. In another embodiment, the device 20 incorporates an electronic or digital scale to weigh the food contained on the utensil portion 22. However, it should be appreciated that the device 20 may incorporate any appropriate type of weighing or measuring mechanism as would generally occur to one skilled in the art.

The device 20 is cleaned after use by removing the serving utensil portion 22 from the handle portion 21. The serving utensil portion 22 is cleaned in a manner typical for other similar kitchen utensils. The handle portion 21 is cleaned in a manner consistent with devices containing sensitive electronic circuitry.

Further, any theory, mechanism of operation, proof, or finding stated herein is meant to further enhance understanding of the present disclosure, and is not intended to limit the present disclosure in any way to such theory, mechanism of operation, proof, or finding. While the disclosure has been illustrated and described in detail in the drawings and foregoing description, the same is to be considered as illustrative and not restrictive in character, it being understood that only selected embodiments have been shown and described and that all equivalents, changes, and modifications that come within the spirit of the disclosures as defined herein or by the following claims are desired to be protected.

What is claimed is:

1. A food serving apparatus, comprising:
a utensil portion configured to receive a quantity of food;
a handle portion operably coupled to said utensil portion; and
electronics including a data input system disposed on said handle portion, wherein said data input system is operable to receive nutritional data associated with the food, said nutritional data including a standard serving size weight of the food, wherein said electronics are operable to weigh the quantity of food received on said utensil portion and produce an indication representing the quantity of food received on said utensil portion relative to the standard serving size of the food.

2. The apparatus of claim 1, comprising a display device disposed on said handle portion, wherein said indication is a visual indication and said visual indication is displayed on said display device.

3. The apparatus of claim 2, wherein said visual indication is a graphical indication.

4. The apparatus of claim 1, comprising a decorative cover removably covering said handle portion.

5. The apparatus of claim 4, wherein said cover includes a germicide substance.

6. The apparatus of claim 1, wherein said indication is auditory.

7. The apparatus of claim 1, wherein said indication is a vibration.

8. The apparatus of claim 1, wherein said electronics include memory operable to store the nutritional data received via said data input system.

9. The apparatus of claim 1, wherein said utensil portion is selected from the group consisting of a spoon, a fork, a spatula, an ice cream scoop, and a spoon containing slotted openings.

10. The apparatus of claim 1, wherein said data input system is a set of operator control buttons.

11. The apparatus of claim 1, wherein the nutritional data further includes a caloric quantity associated with the standard serving size of the food.

12. The apparatus of claim 11, wherein said electronics are further operable to display the caloric quantity associated with the standard serving size of the food.

13. The apparatus of claim 1, wherein the nutritional data further includes at least another quantity associated with the standard serving size of the food, the at least another quantity being selected from the group consisting of a caloric quantity, a carbohydrate quantity, a fat quantity, a sugar quantity, and a fiber quantity.

14. The apparatus of claim 1, wherein said data input system is further operable to receive data representing a personalized daily caloric intake quantity, wherein said electronics are operable to determine a personalized serving size of the food based on the personalized daily caloric intake quantity and the standard serving size of the food, wherein said electronics are operable to produce an indication representing the quantity of food received on said utensil portion relative to the personalized serving size of the food.

15. A portion control, food serving system, comprising:
a series of two or more interchangeable utensil portions configured to receive an amount of food;
a handle portion, removably and operably attachable to one of said utensil portions, incorporating a display device and a data input system, wherein said data input system is operable to receive nutritional data associated with the food, said nutritional data including a standard serving size amount of the food; and
a measuring mechanism operable to weigh the amount of food received on one of said utensil portions, wherein said handle portion includes electronics operable to provide a visual representation on said display device of the amount of food received on the utensil portion attached to the handle portion relative to the standard serving size amount of the food.

16. The system of claim 15, comprising at least one decorative cover configured to removably cover at least a part of said handle portion.

17. The system of claim 15, wherein said data input system is further operable to receive data representing a daily calorie amount, wherein said electronics are operable to determine a personalized serving size amount of the food based on the daily calorie amount and the standard serving size amount of the food, wherein said electronics are operable to produce an indication representing the amount of food received on the utensil portion attached to the handle portion relative to the personalized serving size amount of the food.

18. A food serving apparatus to control the portion size of food consumed by a user, comprising:
a utensil portion configured to receive a quantity of a first food item;
a handle portion operably coupled to said utensil portion; and
electronics operable to receive data input including nutritional data associated with the first food item and at least a second food item, said electronics including memory to store the data input, wherein the nutritional data includes a standard serving size weight of each of the food items, wherein said electronics are further operable to weigh the quantity of the first food item received on said utensil portion and provide an indication representing the weight of the quantity of the first food item received on said utensil portion relative to the standard serving size weight of the first food item received on said utensil portion.

19. The apparatus of claim 18, comprising at least one cover configured to removably cover at least a part of said handle portion, wherein said cover includes a material having application of a germicidal substance.

20. The apparatus of claim 18, wherein the nutritional data further includes a caloric quantity associated with each of the standard serving size weights of each of the food items.
